(19) United States
(12) Patent Application Publication
(10) Pub. No.: US 2012/0270188 A1
(43) Pub. Date: Oct. 25, 2012

(54) EDUCATIONAL SYSTEMS

(76) Inventor: Chantia Necole DALTON, Jamaica, NY (US)

(21) Appl. No.: 13/352,046

(22) Filed: Jan. 17, 2012

Related U.S. Application Data
(60) Provisional application No. 61/433,090, filed on Jan. 14, 2011.
(60) Provisional application No. 61/469,197, filed on Mar. 30, 2011.
(60) Provisional application No. 61/563,162, filed on Nov. 23, 2011.

(51) Int. Cl. G09B 17/00

(52) U.S. Cl. 434/178

(57) ABSTRACT

An educational kit including 1) a pre-assembled literary book containing text and a rotating photo sleeve into which photographs relating to the text may be inserted and predesignated space for recording documenting information or an electronic template therefore and 2) a task card including an “activity” section with suggested activities, a' “photo list” section with a search and find challenge, and a “record recording” section with spaces for written recording of the date of the document or a computer program. These kits may be used, in particular in teaching and improving reading skills.

### CROSS REFERENCE APPLICATIONS

This application claims priority from Ser. No 61/433,090 filed on Jan. 14, 2011, application Ser. No. 61/469197 filed on Mar. 30, 2011 and Application Ser. No 61/563162 filed on Nov. 23, 2011, the contents of all of which are herein incorporated by reference.

### FIELD OF THE INVENTION

The present invention relates to educational methods and equipment.

U.S. Pat. No. 7,487,999 describes a repetitive language kit combined with a series of early reading experiences that facilitate the teaching of reading to pre-readers. The kit is comprised of an assembly of pages that present a photographic site for receiving a personalized photograph and a text site for receiving repetitive and personalized text relating to the photograph as part of a theme. A binder secures the pages between front and back covers and provides movement of the pages through an arc. Cards having repetitive text corresponding to the repetitive text of the pages reinforce and further the reading skills of the pre-reader. The process for creating the book comprises memorializing an experience between a person and pre-reader through photographs, affixing the photographs to the pages of the kit, compiling the pages into a bound book and reading the book to the pre-reader who memorizes and play reads along.

U.S. Pat. No. 7,627,809 describes a method of creating a document having a displayable area on which information is placed, the method comprising providing a plurality of content-items which contain information that it is possible to display on the displayable area, dividing the displayable area into a set of sub-areas each capable of receiving one or more of the content-items, generating at least one set of proposed arrangements in which the content-items have been arranged within the set of sub-areas, selecting at least one of the proposed arrangements, according to predetermine criteria, as the layout of the content-items within the sub-areas of the displayable area to create the document; and causing a printing means to print the created document.

### SUMMARY OF THE INVENTION

The present invention comprises four aspects which may be used independently or on combination with each other.

In its first aspect, the invention provides a method and process of documenting through the use of inserting photographs, documents and/or objects into a pre-assembled literary book containing text with a board book bind and a rotating photo sleeve into which photographs relating to the text may be inserted The book is used in conjunction with a task card. The task card includes an “activity” section with suggested activities, a “photo list” section with a search and find challenge, a “record recording” section with spaces for written recording of the date of the document, and optionally a “great read” section with suggestions for moments to read and re-read the document, and a “pondering” section with questions and word activities or journal prompts.

This aspect further comprises a method of reading development wherein a student is provided with a book as described above, inserts photographs in the book and executes tasks related to said photograph in accordance with the task card.

The second aspect of the invention utilizes and an electronic book variant of the first. It provides a kit including: (1) an electronic templates of a literary book that includes text, graphic designs, illustrations, a picture list as a guide on a search and hunt for photo capture, and empty fields for user input/attachment, (2) a computer program that allows users to register into a database that provides a means for creating and implementing the electronic book.

This aspect further provides a method of implementing an electronic book uses (a) listening to and reading the electronic book as a literary and entertaining agent, (b) sharing the book through a network of other network participants, (c) printing the electronic book onto a plurality of pages.

The third aspect of the invention provides a computer implemented method of reading development by completing, reading and engaging with photo documents includes (a) searching for or creating moments and objects for photo capture; (b) capturing all of the required photos/images/documents/video of the picture list in a kit as set out for the first and second aspects of the invention; (c) reading photo documents from a library of photo documents; (d) engaging in related real experience activities as well as media interactive activities; (e) setting reading settings for user enjoyment and reading effectiveness; (f) receiving reading incentives and achievement feedback; (g) applying knowledge and thoughts to related questions.

In a fourth aspect the present invention provides a method of accessing specific information within an Electronic Photo Documentary Library utilizes (1) a progressive incentive library system with account features and functions; (2) Portals that contain EPDB and or Library Activities; (3) Photo lists; (4) an Electronic Photo Documentary Maker; (5) an Electronic Photo Documentary Reader and Web Link.

### BRIEF DESCRIPTION OF THE DRAWINGS

FIGS. 1-3 depict the steps involved in creating a pre-assembled rotating photo documentary book according to the first aspect of my invention.

FIG. 4 is a flow chart depicting the steps taken according to the aspect of the invention.

FIG. 5 shows a lay out for Version 1 of the second aspect of my invention.

FIG. 6 shows a lay out for Version 2 of the second aspect of my invention.

FIG. 7 is an annotated screen shot of a step in the second aspect of my invention.

FIG. 8 is a flow chart depicting the third aspect of my invention.

FIG. 9 is an annotated screen shot of a screen of use in the third aspect of my invention.

FIG. 10 depicts settings available on the main page of the third aspect of my invention.

FIG. 11 is a flow chart depicting the fourth aspect of my invention.

FIG. 12 is an annotated screen shot of a screen of use in the fourth aspect of my invention.

FIG. 13 is a screen shot of use in the fourth aspect of my invention.

FIG. 14 shows a photo documentary maker for versions of my invention.

FIGS. 15 and 16 illustrate methodology that may be used in the fourth aspect of my invention.

FIG. 17 summarizes information to be included in all electronic book versions of my invention.

### DETAILED DESCRIPTION OF THE INVENTION

In its first aspect, the present invention provides a method and process of documenting through the use of inserting photographs, documents and/or objects into a pre-assembled literary book with a board book bind and a rotating photo sleeve. The person(s) creating the photo documentary is/are the documenter(s). Photo Documentaries document a specific subject matter and include a front and back cover, inner pages, a pocket, rotating sleeves, subject specific literary text, and a subject specific task card. The task card is used as the process for implementing, completing and extending the photo document. Task card includes an “activity” section with suggested activities, a' “photo list” section with a search and find challenge, a “record recording” section with spaces for written recording of the date of the document, a “great read” section with suggestions for moments to read and re-read the document, and a “pondering” section with questions and word activities or journal prompts.

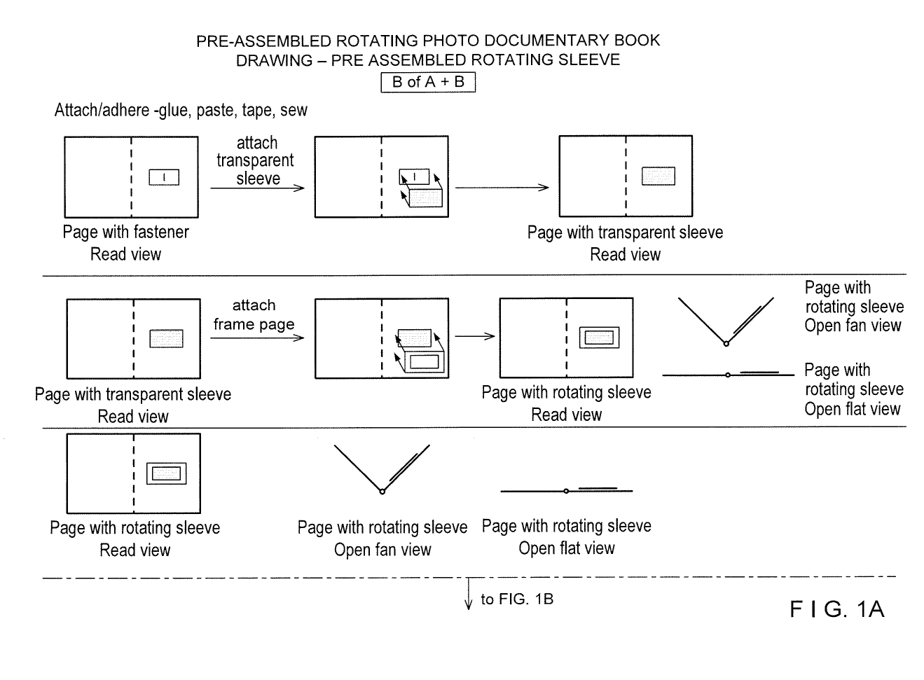

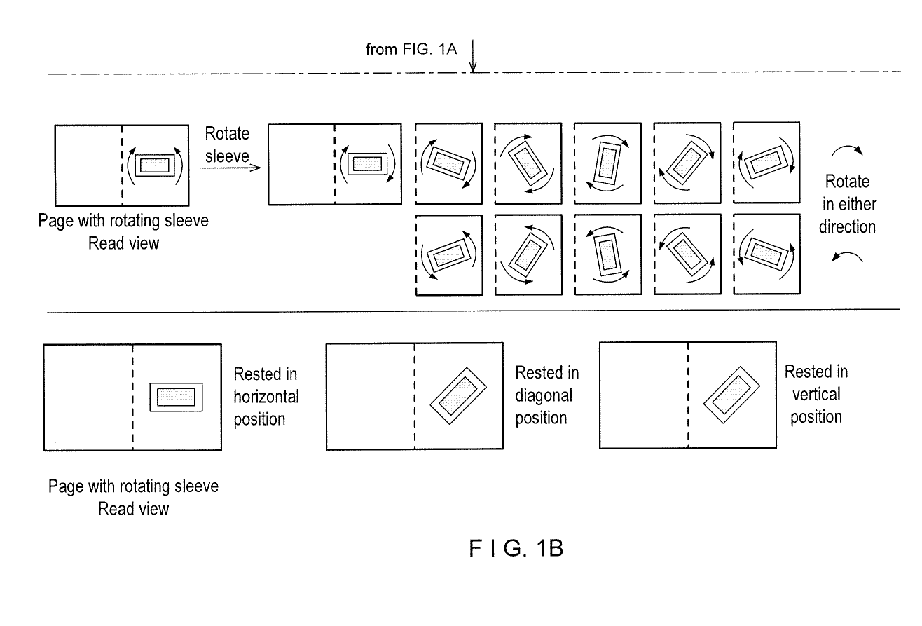

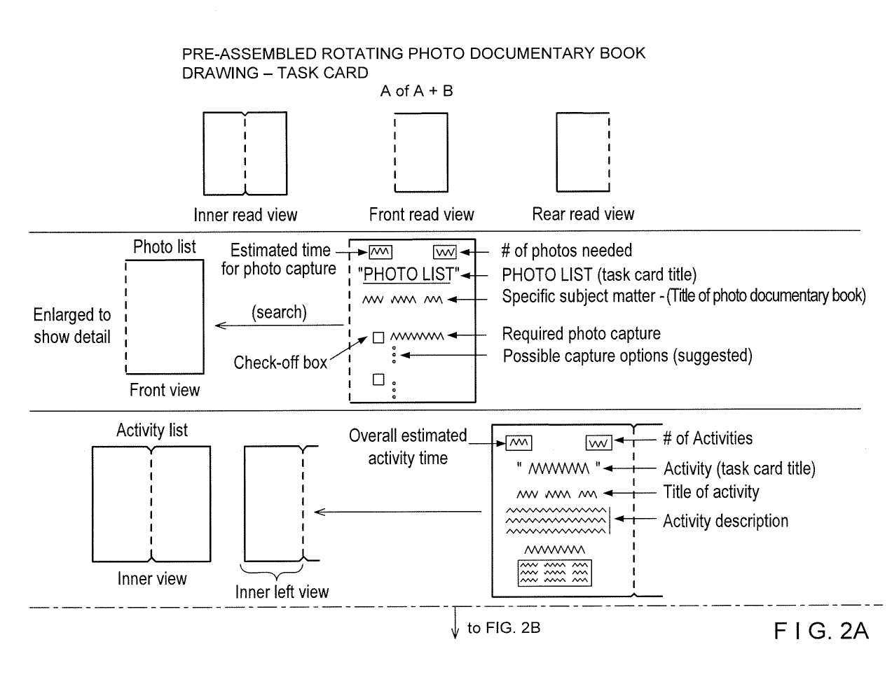

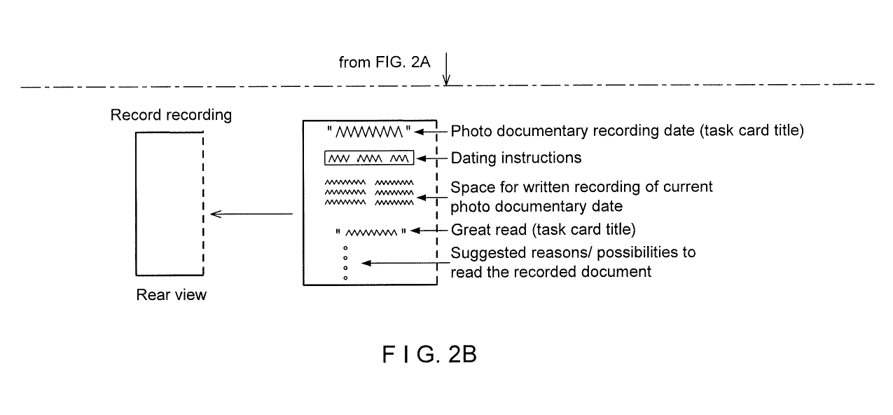

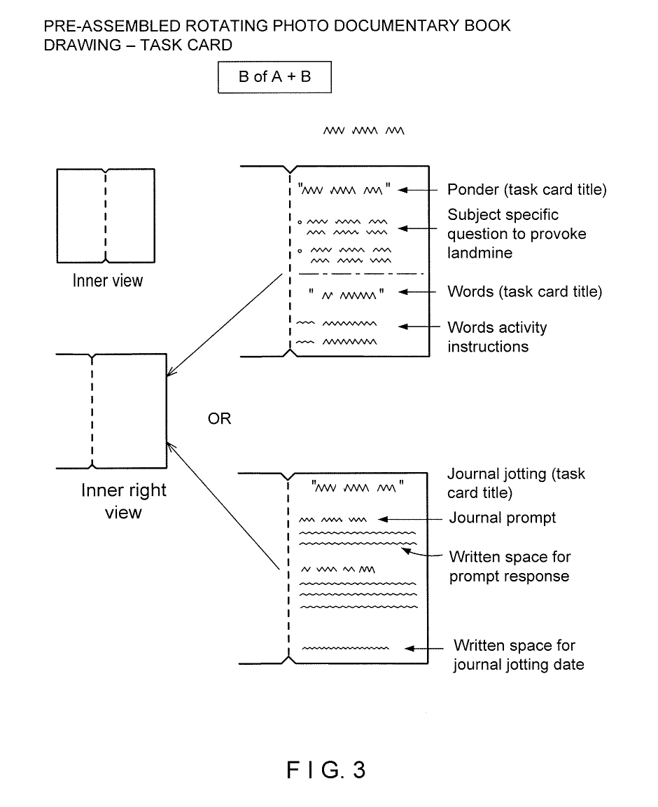

Some Photo Documentaries include interactive magnetic text. How these elements combine to become the Pre-assembled Rotating Photo Documentary Book is described below and illustrated in FIGS. 1-3.

This invention utilizes the method of photo documenting by compiling printed matter of information with photos and objects pertaining to a specific subject matter within a preassembled literary book. This invention creates a record by way of an identifying photo to determine ownership, printed information with photographic proof, and a date. This invention allows people to record their experiences, opinions, status', emotions, personal information, periods of time, and moments in time for the purposes of documenting, memorializing, entertaining, and learning. This method of photo documenting is referred to as “Photo Documentary” within the title of the invention.

This invention's method of creating a photo documentary utilizes the process where the documenter journeys on a pictorial adventure with the use of a subject specific photo list as a guide for creating and/or locating people, places, and objects for photo capture. The documenter selects a pictorial adventure based on the specific subject matter noted in the title of the book and/or the correlation of the required photos on the photo list. The pictorial adventure is conducted by searching for and capturing the required photos on the photo list

The photo list serves as an adventurous challenge of search and find for the documenter. Along with the challenge of the photo list, the documenter is physically and mentally involved with the activities and pondering of the task card. The task card allows the documenter to re-enact, locate, and/or create photos for capture, ponder about the specific subject matter, and date the documentary. When the documenter has completed the challenge he/she prints the photographs and inserts them into the book's rotating photo sleeve appropriately aligned to the literary text. The documenter then completes the photo documentary by placing the current date in the “Record Recording section of the task card.

The rotating photo sleeve serves as a transparent holder of photographs, documents, and/or objects to visually represent what is being recorded. The photo sleeve spins in a circular motion allowing the documenter to insert photos captured either in the width or length position. This circular motion is referred to as “Rotating” in the title of the invention. An appropriately sized photo is properly placed into the transparent sleeve and then rotated into the correct position for aesthetic view. The sleeve is capable of resting in either a horizontal, vertical, or diagonal position. The rotating sleeve is assembled onto each page of the book by way of a flat head, push through paper fastener, a thin mini rubber washer, an additional page sized closer to the size of the sleeve, a transparent sleeve, and a frame page. The fastener attaches both pages by sliding through the hole of the rubber washer, then through the additional page, then through the page of the book. The fastener opens and spreads its two prongs behind the page of the book and fastens the two pages together so that while one page is in a stationary position the other page can rotate continuously on the axis of the fastener and then rest in a varied stationary position. The transparent sleeve is then adhered to the additional page. The frame page is then adhered to the transparent sleeve for aesthetic view.

The frame page has a sizable hole in its center to serve as a window for viewing the contents of the sleeve as would a traditional frame. The documenter is not required to assemble the rotating photo sleeve because it is already assembled and referred to as “Pre-assembled” in the title of the invention. The said invention requires the documenter to insert relevant photos, documents, and/or objects into a pre-assembled literary book. Already assembled is a front cover, back cover and an array of inner pages with rotating sleeves. The front cover includes a title, author, illustrations, and notation of the book series. The outer back cover is equipped with a pocket for storing the subject specific task card and alternative photos, objects, and/or documents.

The array of inner pages includes text and rotating transparent sleeves with frames on durable paper like, card stock material. The text includes publishing information, product/author information, and entertainingly factual information pertaining to a specific subject matter.

The entertaining factual information is expressed in elaborate descriptive text. The factual gist of the information is represented as an item on the photo list. The documenter prints the photos captured according to the photo list and inserts the photo into the appropriately aligned rotating sleeve. The front and back cover along with the array of inner pages are preassembled, also referred to as “Preassembled” in the title of the invention. The assembly of the book uses a board book bind for durability, a flat open view, and a smooth page turn for easy view and handling. Inner pages of descriptive and informative text bound between a front and back cover is what is referred to as “Book” in the title of the invention.

Some Pre-assembled Rotating Photo documentary Books are designed for young readers as literary literature tools for the purpose of improving reading abilities. The process by which the documenter/reader utilizes the Pre-assembled Rotating Photo Documentary Book for improving reading is by the way of making relevant text connections, retaining the photo documentary by placing the current date in the “Record Recording section of the task card.

The rotating photo sleeve serves as a transparent holder of photographs, documents, and/or objects to visually represent what is being recorded. The photo sleeve spins in a circular motion allowing the documenter to insert photos captured either in the width or length position. This circular motion is referred to as “Rotating” in the title of the invention. An appropriately sized photo is properly placed into the transparent sleeve and then rotated into the correct position for aesthetic view. The sleeve is capable of resting in either a horizontal, vertical, or diagonal position. The rotating sleeve is assembled onto each page of the book by way of a flat head, push through paper fastener, a thin mini rubber washer, an additional page sized closer to the size of the sleeve, a transparent sleeve, and a frame page. The fastener attaches both pages by sliding through the hole of the rubber washer, then through the additional page, then through the page of the book. The fastener opens and spreads its two prongs behind the page of the book and fastens the two pages together so that while one page is in a stationary position the other page can rotate continuously on the axis of the fastener and then rest in a varied stationary position. The transparent sleeve is then adhered to the additional page. The frame page is then adhered to the transparent sleeve for aesthetic view.

The frame page has a sizable hole in its center to serve as a window for viewing the contents of the sleeve as would a traditional frame. The documenter is not required to assemble the rotating photo sleeve because it is already assembled and referred to as “Pre-assembled” in the title of the invention.

The said invention requires the documenter to insert relevant photos, documents, and/or objects into a pre-assembled literary book. Already assembled is a front cover, back cover and an array of inner pages with rotating sleeves. The front cover includes a title, author, illustrations, and notation of the book series. The outer back cover is equipped with a pocket for storing the subject specific task card and alternative photos, objects, and/or documents. The array of inner pages includes text and rotating transparent sleeves with frames on durable paper like, card stock material. The text includes publishing information, product/author information, and entertainingly factual information pertaining to a specific subject matter.

The entertaining factual information is expressed in elaborate descriptive text. The factual gist of the information is represented as an item on the photo list. The documenter prints the photos captured according to the photo list and inserts the photo into the appropriately aligned rotating sleeve. The front and back cover along with the array of inner pages are preassembled, also referred to as “Preassembled” in the title of the invention. The assembly of the book uses a board book bind for durability, a flat open view, and a smooth page turn for easy view and handling Inner pages of descriptive and informative text bound between a front and back cover is what is referred to as “Book” in the title of the invention.

Some Pre-assembled Rotating Photo documentary Books are designed for young readers as literary literature tools for the purpose of improving reading abilities. The process by which the documenter/reader utilizes the Pre-assembled Rotating Photo Documentary Book for improving reading is by the way of making relevant text connections, retaining subject specific information and literary skills and concepts by way of physical and emotional involvement, and mental application of subject matter by way of pondering as a result of questioning.

Completing a Pre-assembled Photo Documentary Book provides a reader/documenter with text that is directly related to them self. The documenting of actual experiences allows the reader/documenter to directly relate and connect to the literature within the Pre-assembled Photo Documentary Book resulting in a self-to-text connection. When the reader/documenter reads someone else's Pre-assembled Photo Documentary Book of the same specific subject matter(s) in which they have already created, there is an additional opportunity for text-to-text connections.

With completion of various Pre-assembled Rotating Photo Documentary Books, the reader/documenter is able to store the experiences as prior knowledge for future books pertaining to similar subject matters. Additional text-to text connections are possible when this said prior knowledge is recalled from photo documentary during the reading of any type of literature. Literary research proves, these types of literary connections, allows the text to become relevant to the reader resulting in an improvement of reading interests and comprehension.

There is literary research regarding retaining information and how it is best clone when the informed is physically and or emotionally involved with the information. The Preassembled Rotating Documentary Book's task card includes a subject specific photo list, subject specific activities to perform, subject specific questions to ponder, and/or subject specific journal prompts with space for written recordings. The implementation of the task cards, physically and emotionally involve the reader/documenter with the overall experience of photo documenting improving the possibility for literary concept and skill retaining. The reader/documenter physically creates, re-enacts, and/or searches for items listed on the photo list. The documenter/reader physically involves and performs the activities on the task card. The process of capturing, taking, printing, and inserting the photos into the book requires physical involvement. The questions and journal prompts of the task card mentally involve the reader/documenter resulting in an emotional involvement. This physical and mental involvement of the reader/documenter while photo documenting, improves the possibility of retaining the subject specific information as well as the literary skill and concept.

Information is confirmed as knowledge when it is recalled upon during questioning or prompting. The “pondering” section of the task card includes an assortment of questions, word activities, and journal prompts regarding the subject specific information and literary skills and concepts. The questions elicit literal and figurative analysis of the literature. The documenter/reader may verbally, write, or internally respond to the questions and prompts. The word activities relate specifically to the words of the text and require the reader/documenter to manipulate, create, and locate specific words or situations within the text. The journal prompts bring forth the documenter/reader to record their mental and physical applications during the photo documenting experience. The knowledge of the reader/documenter may broaden when the pondering evokes examining and analyzing from another perspective. These mental applications to the subject specific subject matter, words of the text, and literary skills and concepts increase the possibility of reading comprehension.

Pre-assembled Rotating Photo Documentary Books catered to young readers are apart of thematic units. Thematic units are comprised of a variety of Pre-assemble Photo Documentary Books devised to accommodate a specific age, reading level, and reader's interests. The documenting literature is intended to be appealing to the reader by the way of poetic, whimsical, witty informational text. Each thematic unit builds upon the reading level of the previous unit covering the spectrum of reading levels of young readers. Pre-assembled Rotating Photo Documentary Books, devised for young readers, include literary skills and concepts that are built upon by way of units, literary activities for implementation, assessment questions for application, and photo documenting for literary relevance. Some Pre-assembled Rotating Photo Documentary Books catered to young readers are designed to be interactive and personalized with the inclusion of thin letter and word magnets with adhered text. These literary features qualify this invention as a tool for improving reading.

Pre-assembled Rotating Photo Documentary Books differ from other book types. This invention, unlike a scrap-book is pre-assembled. Scrap books require the set-up and joining of pieces where this invention is already assembled and without pieces. Differing from a photo album this invention includes descriptive text that must correlate to the inserted photo, preventing the insertion of a random photograph like standard photo albums. Photo books include both text and photographs but differ from this invention in 3 ways. Firstly, photo books require the maker to compose their own original text/literature. Secondly, photo books require some form of technology to add the photos and print the pages. Thirdly, a photo book's photographs are permanently affixed to the page. Pre-assembled Rotating Photo Documentary Books are furnished with documenting literature, lack the need for any technology, and allow the documenter to change photos within the sleeves. This invention differs from pre-reader photo books. Pre-reader photo books lack the ability to record and document an experience because they lack the inclusion of a documenting date. This invention allows the documenter to document their experiences, opinions, status', emotions, personal information, periods of time, and moments in time with the inclusion of a date. Prereaders teach readers how to read by improving word recognition by the way of matching words with relevant photos. Pre-reader photo books do not require mental assessment or application of knowledge unlike this invention. This invention's literary features include the teaching of literary skills and concepts, directly within the text, reading interests by, making documenter/reader-to-text connections, and reading comprehension by including mental application to the text and experiences. Pre-reader photo books often require assembly or the use of technology in order to complete them and may require the reader to include literary text. This invention is pre-assembled and does not require the reader/documenter to assemble the book nor include literary text. Readers of pre-reader photo books are limited to affixing photos only once and the photo must be captured in the correct position. Preassembled Rotating Photo Documentary Books allow the documenter to insert a photo captured in any position into its rotating sleeve and then months later, re-do the experience and record the experience with new photos.

From a second aspect, the present invention provides a method and process of photo documenting through the use of inputting/attaching photographs, documents and/or video into an electronic literary book.

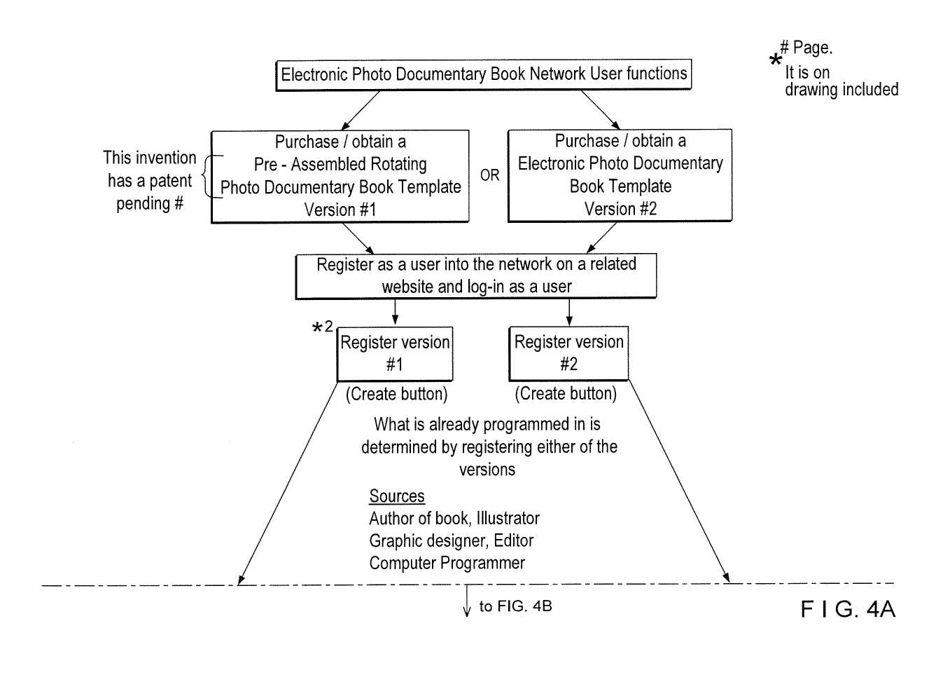

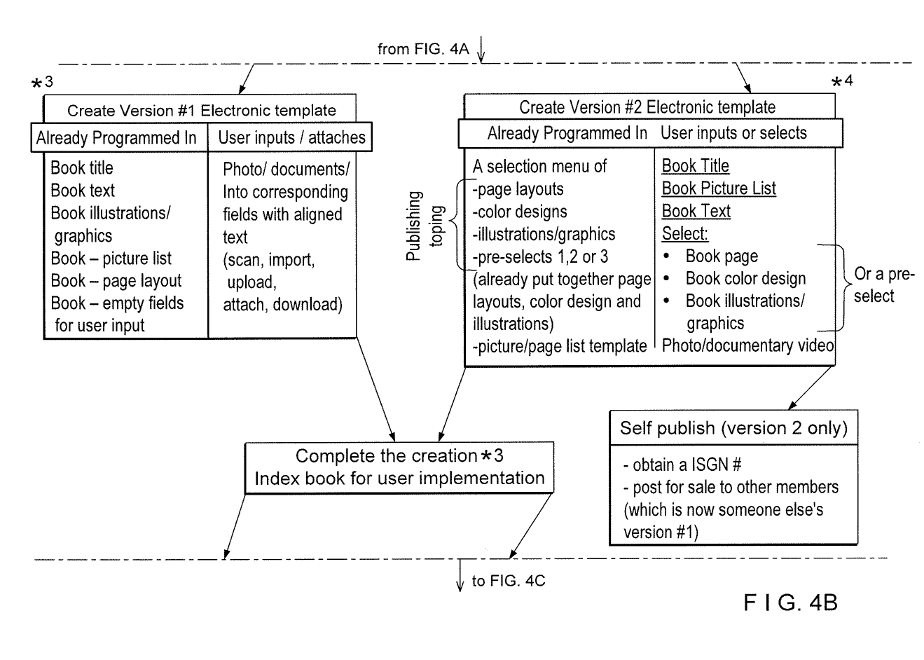

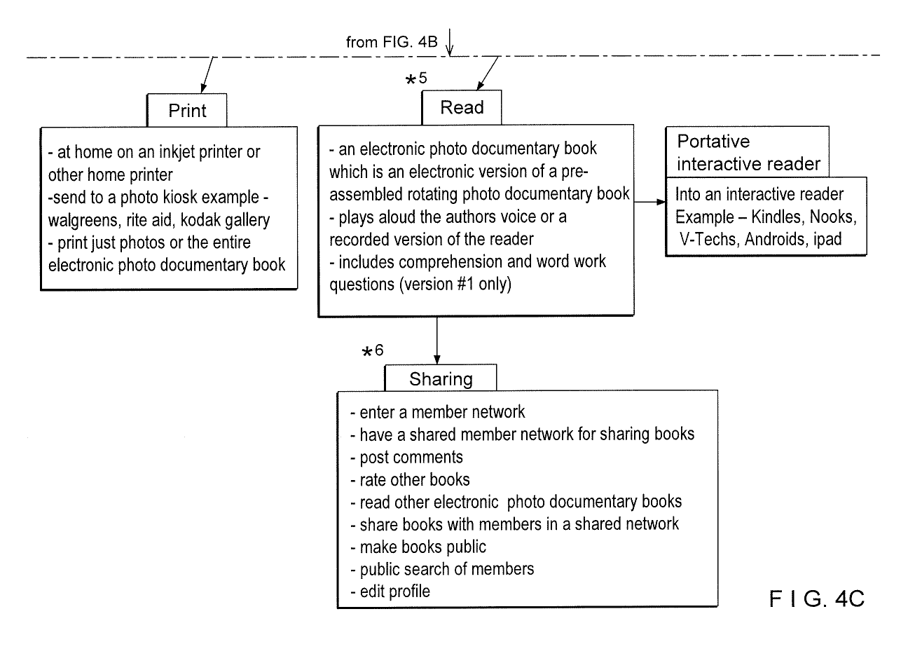

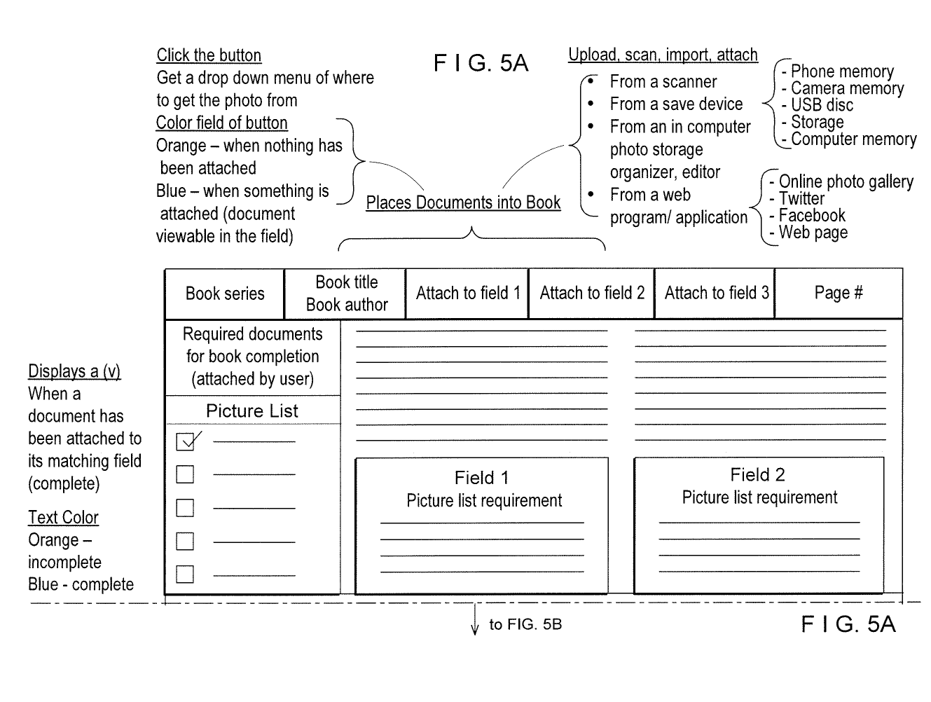

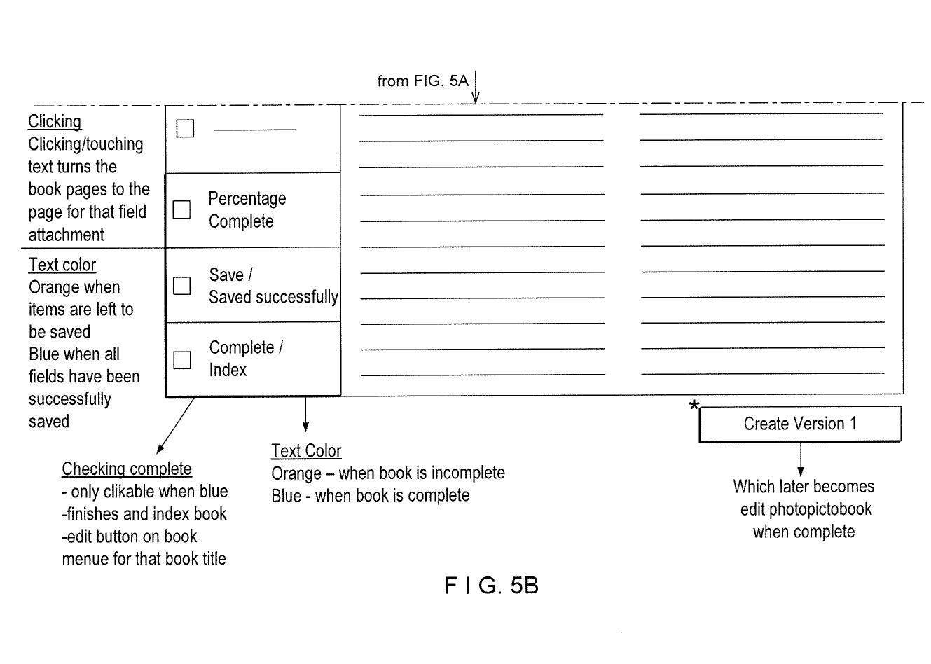

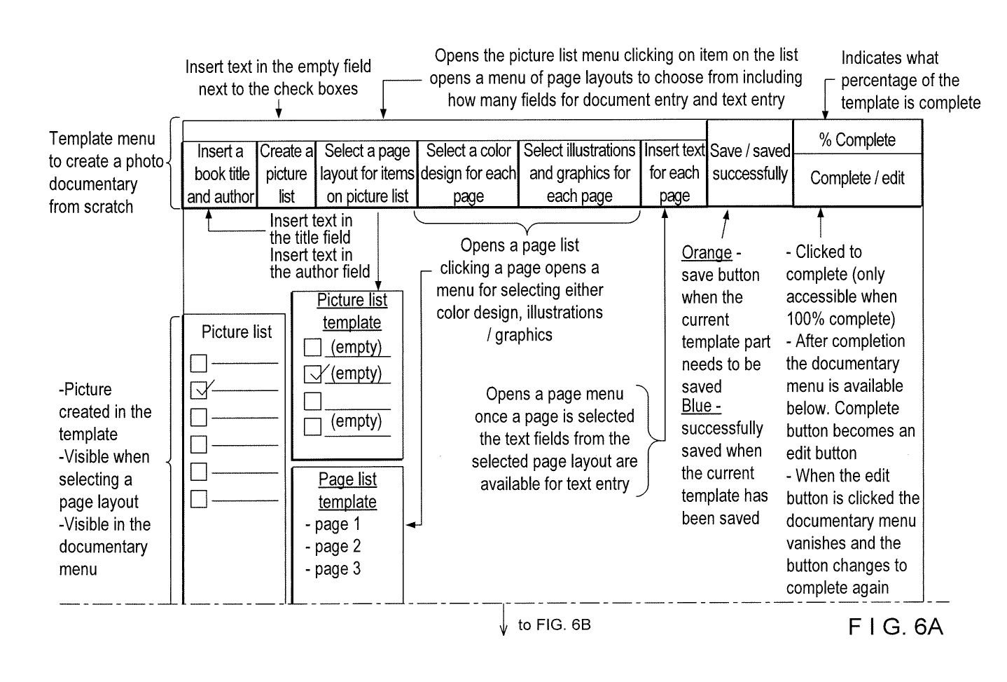

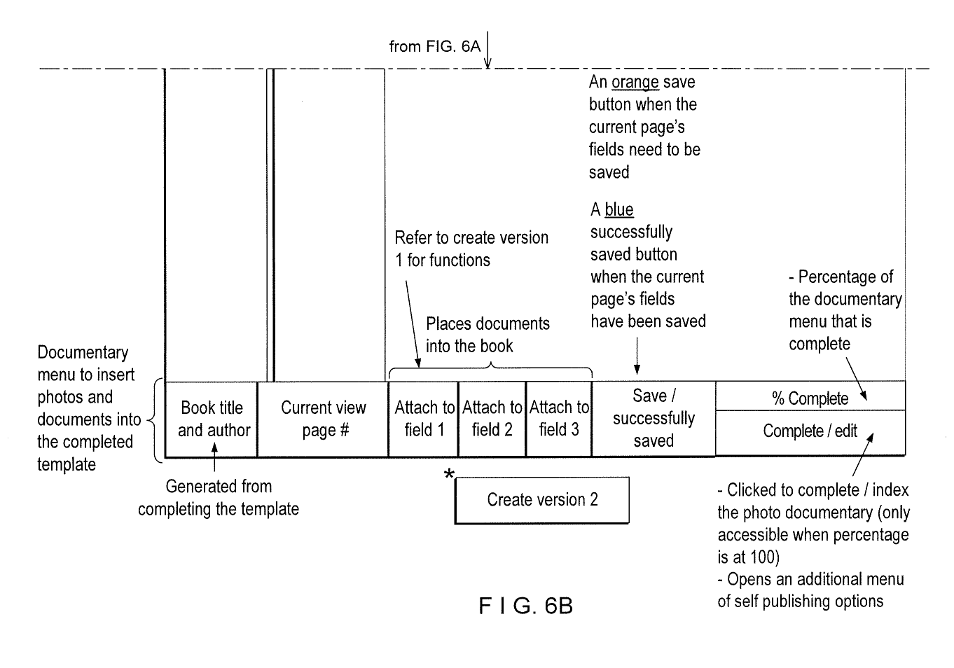

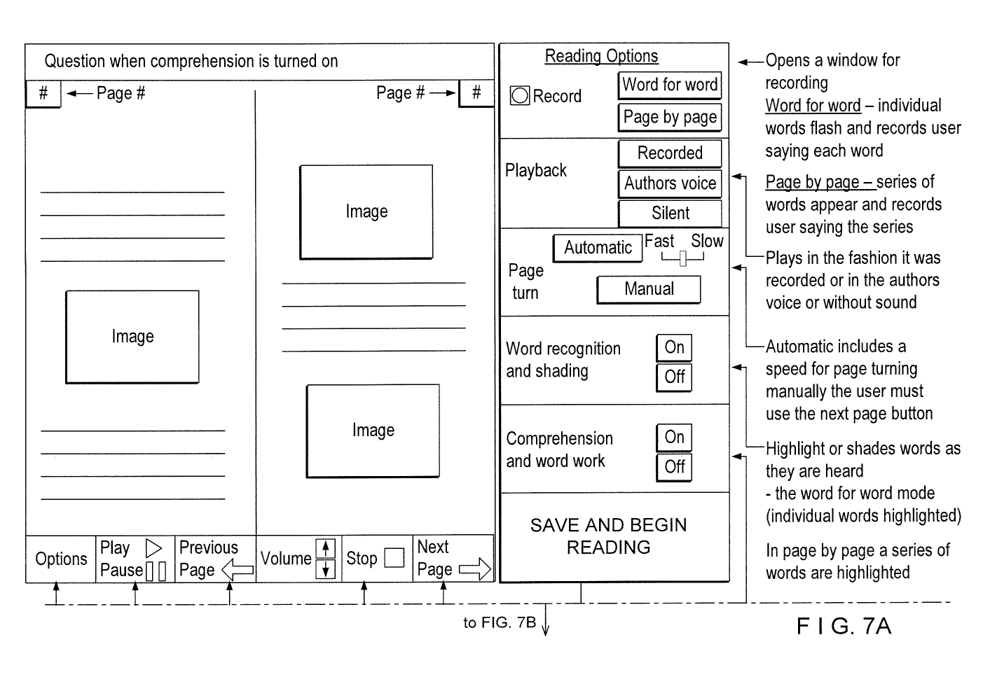

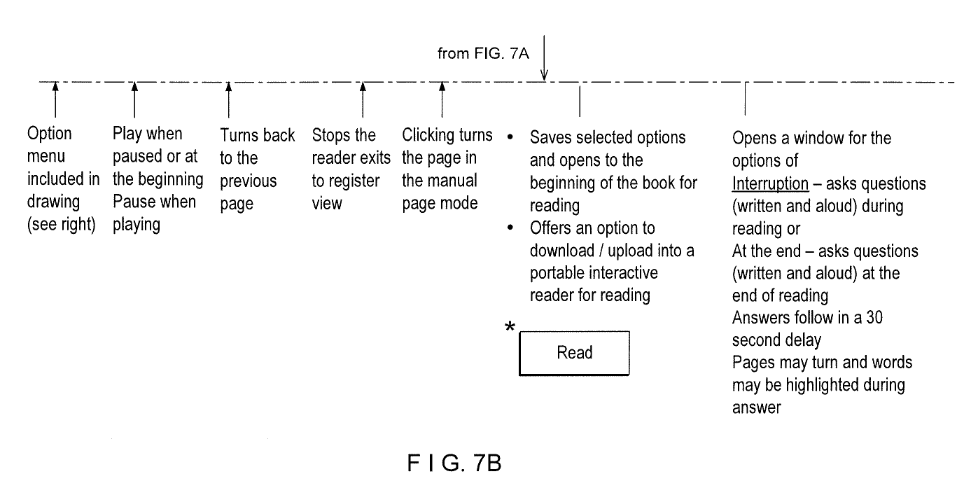

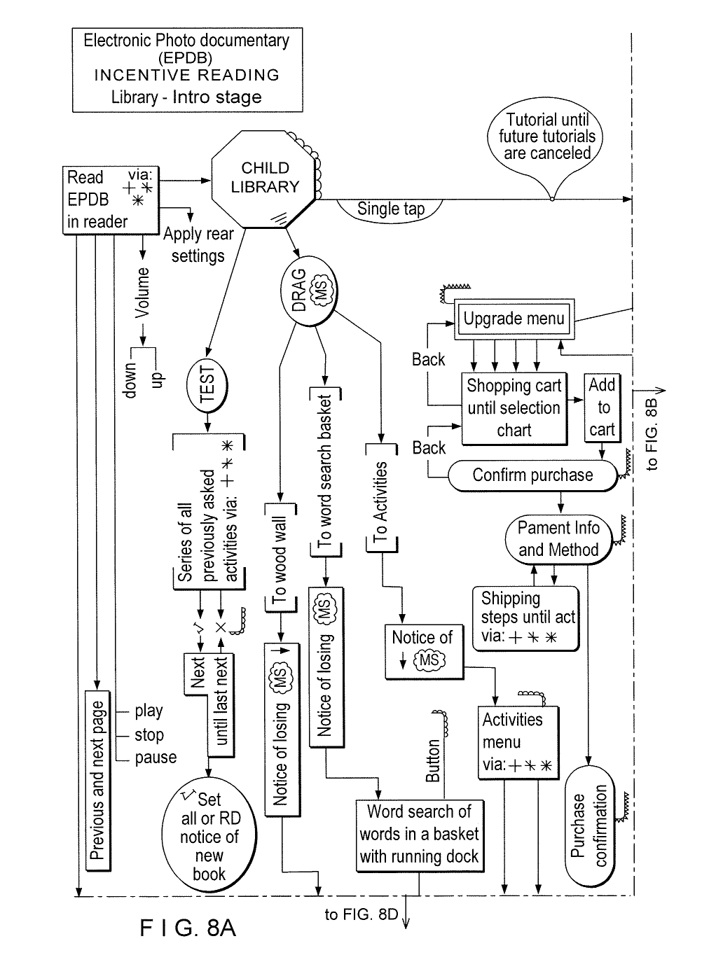

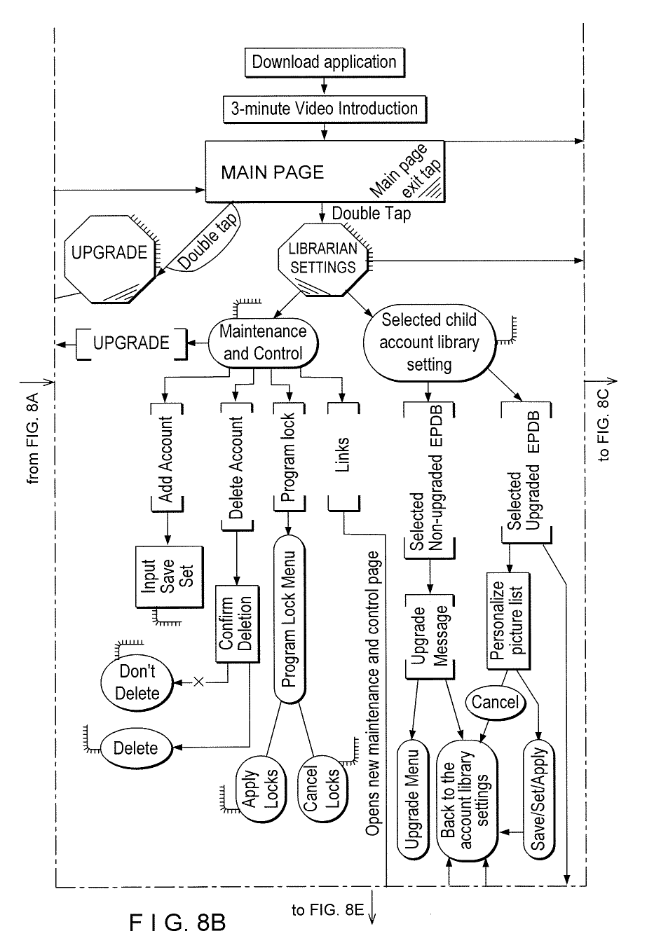

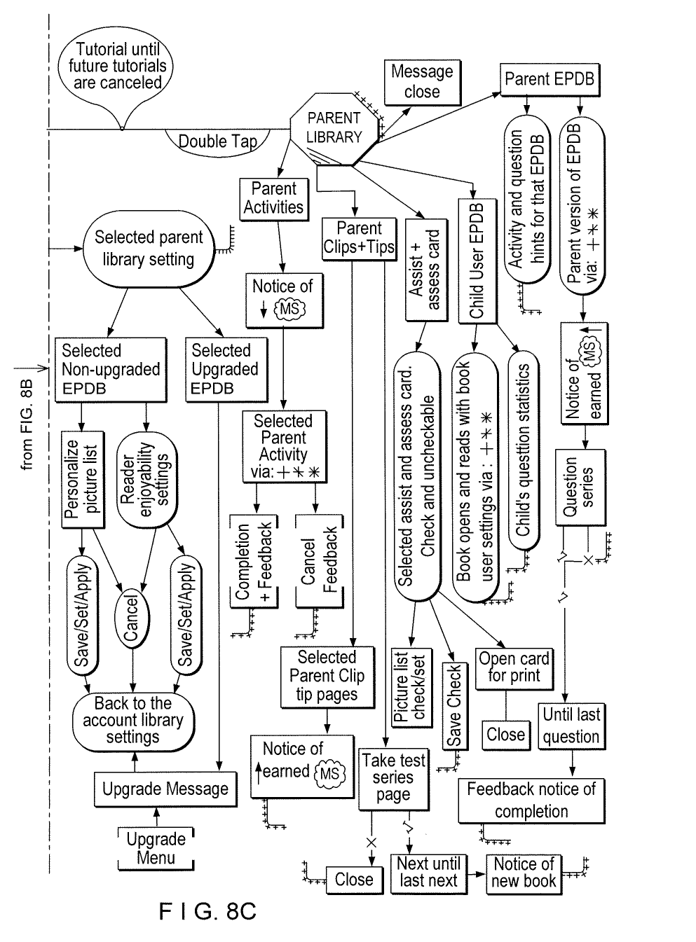

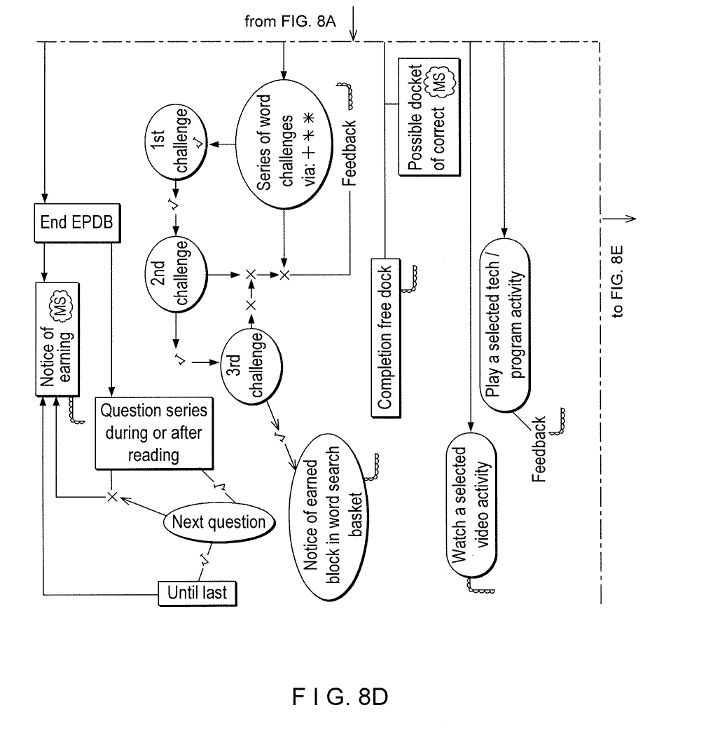

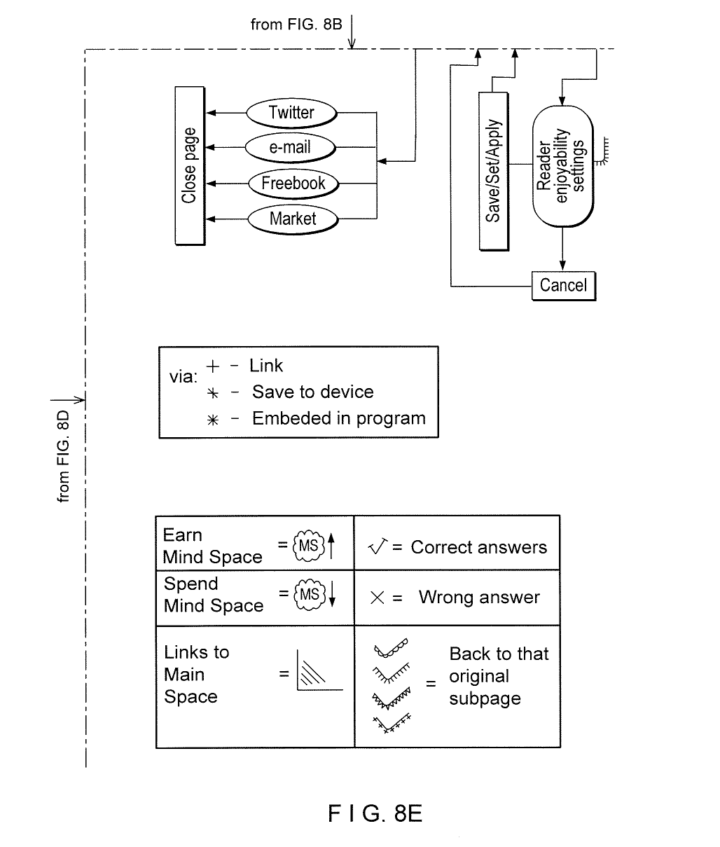

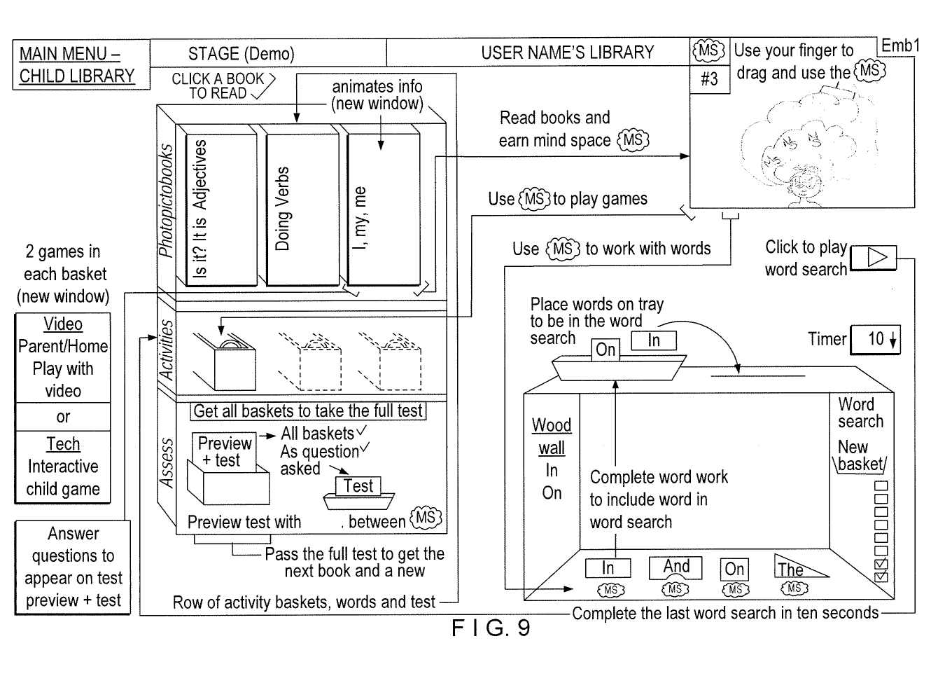

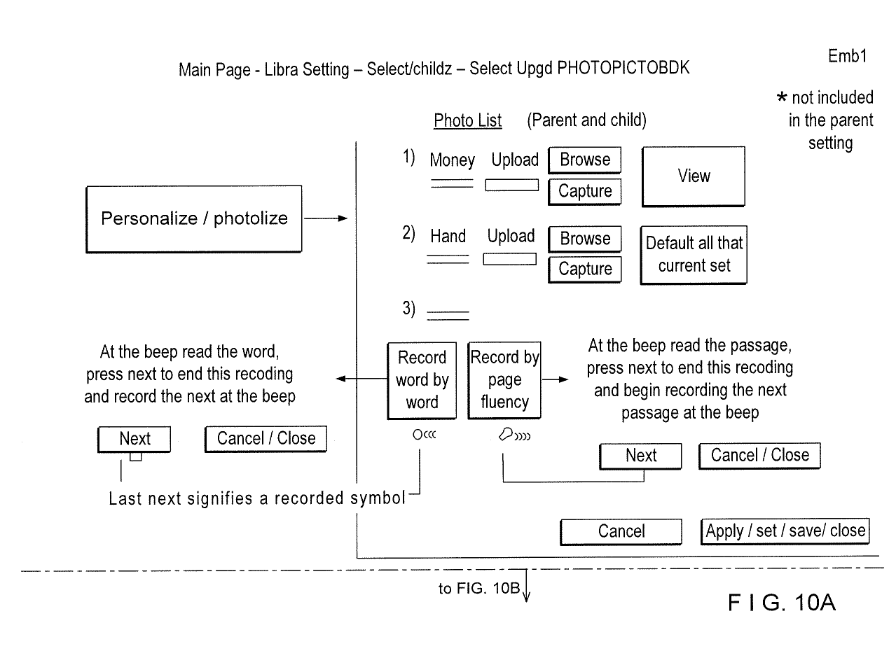

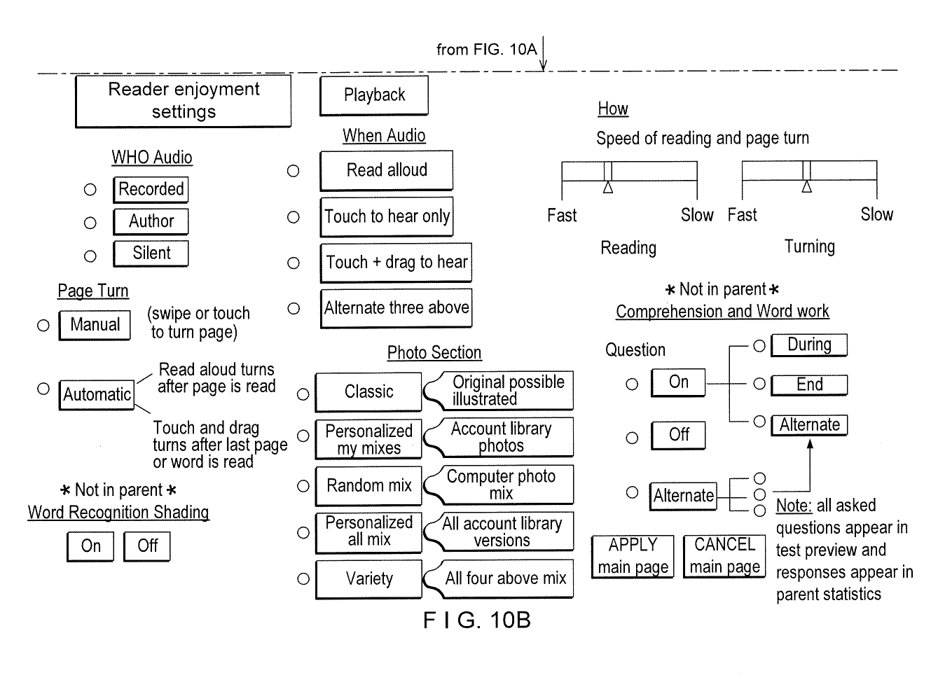

The steps involved in the second aspect of my invention are depicted in FIG. 4 and lay-outs for versions 1 and 2 referred to below are shown in FIGS. 5 and 6. An annotated screen shot used in this version is shown in FIG. 7.

The electronic literary book is a technology extension of the first aspect of the invention. The person(s) creating the Electronic Photo Documentary Book is/are the documenter(s). Photo Documentaries document a specific subject matter and require a method and process of creating and implementing/

This will describe the process of creating the Electronic Photo Documentary Book and the method of implementing the Electronic Photo Documentary Book. The process including the use of (1) an electronic templates of a literary book that includes text, graphic designs, illustrations, a picture list as a guide on a search and hunt for photo capture, and empty fields for user input/attachment, (2) a computer program that allows users to register into a database that provides a means for creating and implementing the electronic book. The method of implementing an electronic book uses (a) listening to and reading the electronic book as a literary and entertaining agent, (b) sharing the book through a network of other network participants, (c) printing the electronic book onto a plurality of pages.

The process of creating an Electronic Photo Documentary Book begins with documenters participating in a computer programmed network of Electronic Photo Documentary Books. Documenters must obtain access to electronic Photo Documentary book templates. After obtaining either version 1 or 2 of the Electronic book templates the user must register the template into a computer network for creating and utilizing the Electronic Photo Documentary Book.Electronic templates version 1 or 2 provide the documenter with a pre-programmed electronic book. Version 1 is pre-programmed with a title, literary text, book illustration and graphics already in a selected page layout, a picture list of required photo captures, and empty fields for documenters to input/attach photos, videos, and or documents. The documenter upload, attaches, input, or downloads photos, videos and or documents into the corresponding empty fields in order to completely create version 1. Version 2 is preprogrammed with a selection of electronic book publishing features including, a picture or page list template, page lay-out options, color design options, graphic and illustration options, as well as options that include an already put together page layouts, color and graphic/illustrations. The documenter must select options off the pre-programmed publishing menu, input a title, book text, picture list requirements, uploads, attaches, input, or downloads photos, videos and or documents into the corresponding empty fields in order to completely create a version 2 template. Version 2 templates also provides documenters with an additional option to self publish their Electronic Photo Documentary Book with the menu choices of obtaining an International Standard Book Number and posting it for sale in order to completely create version 2.

Completely creating an electronic book template provides the reader with a complete and indexed Electronic Photo Documentary Book ready for implementation. Indexing an Electronic Photo Documentary Book provides the documenter with a list of indexed books to implement within the network. Documenters can implement their Electronic Photo Documentary Books by utilizing a print, read, or share function of the network. The print function allows the documenter to print the pages of the created Electronic Photo Documentary Book, or just print the input/attached data. Documenters have the option of printing using their home printer or sending them out to an outsourced photo kiosk. The read function allows the documenter to read the pages of the created Electronic Photo Documentary Book. Documenters select a series of reading options. Prior to reading the documenter has the option to: (a) add a listening feature by recording their self reading the book or upload an author/pre-recorded voice for reading playback of the book, (b) page turn features of automatic or manual, (c) word recognition feature of a follow along highlight/shading (visual aid) of the words to correspond to the playback feature (auditorial aid), (d) a comprehension/word work feature of questions and activities for reader/documenter interaction with the option for interruptions or at the end of reading. Once the documenter has selected the manner in which he/she would like to read their Electronic Photo Documentary Book documenters have the option of reading by uploading/downloading the pages into a portable interactive reader or stationary computer/laptop electronic book reader. Documenters/readers can play, pause and stop reading, turn to the next or previous page, and turn the volume up or down. The share function is accessible after the documenter has read the book. Sharing the book allows the documenter to enter a network of other members who have created and read Electronic Photo Documentary Books and allow other documenters access to reading their Electronic Photo documentary Book. Entering this network allows documenters to: (1) Create a shared network of friends and family, (2) Post books for Purchase, (3) Read and Share complete/indexed Electronic Photo Documentary Books and profile information with other members, (4) use comment posting features, (5) use rating features, (6) maintain and edit a profile for sharing Electronic Photo Documentary Books, (7) Browse a public network member list.

Documenters create a profile by setting profile options to private, public, or shared. Profile options including a user name, age, an index of Electronic Photo Documentary Books, user e-mail address.alist of shared Electronic Photo Documentary Books, list of members/usernames and photos of the family and friends shared network, Electronic Photo Documentary Book Comments, Electronic Photo Documentary Book Ratings, and book recommendations. Once Documenters have created their profile they will have access to Public Network Browsing where they can view all of the members in the network by username and view their profiles according to profile settings. Documenters may send requests or accept requests from other members to be apart of a shared network where there is an ability to share Electronic Photo Documentary Books. Documenters can read other members shared Electronic Photo documents in the pre-set reading settings. Once documenters have read another member's Electronic Photo Documentary Book they may post a comment to the book and/or rate the book in a survey of pre-selected criteria. Documenters have the option to post Electronic Photo Documentary Books they have for sale after completing a Version 2 template.

This description includes the method and process of creating and implementing an Electronic Photo Documentary Book. This description does not include but implicates the benefits and attributes of creating a photo documentary from obtaining the correlated/interrelated invention titled Pre-assembled Rotating Photo Documentary Book. This description does not include but implicates the benefits and attributes of the literary literature tools in creating and reading a photo documentary from obtaining the correlated/interrelated invention titled Pre-assembled Rotating Photo Documentary Book.

In a third aspect the invention provides a Electronic Photo Documentary Shared Reading Development and Incentive Library.

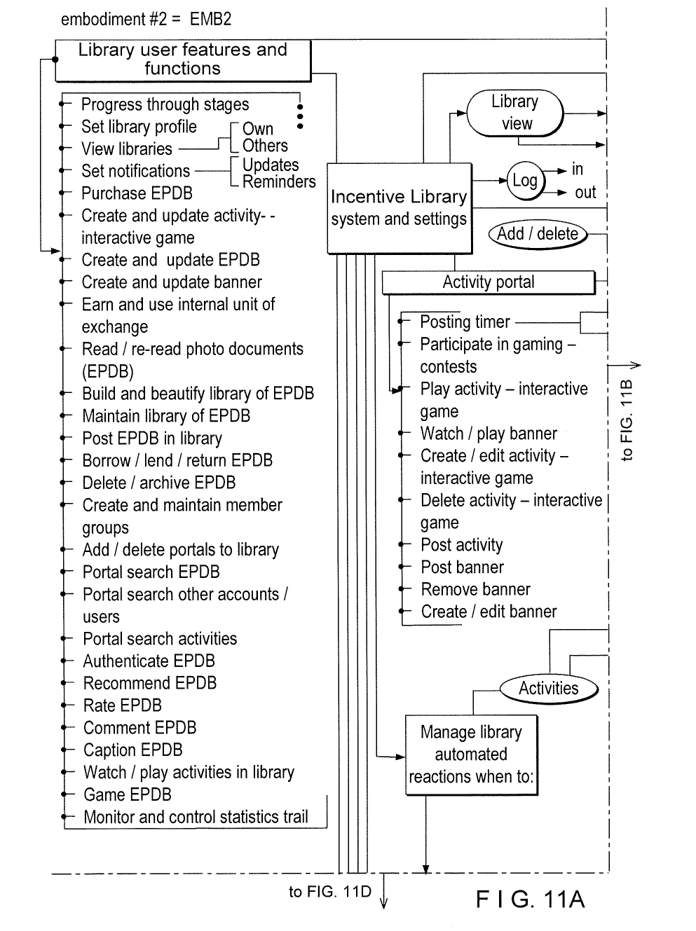

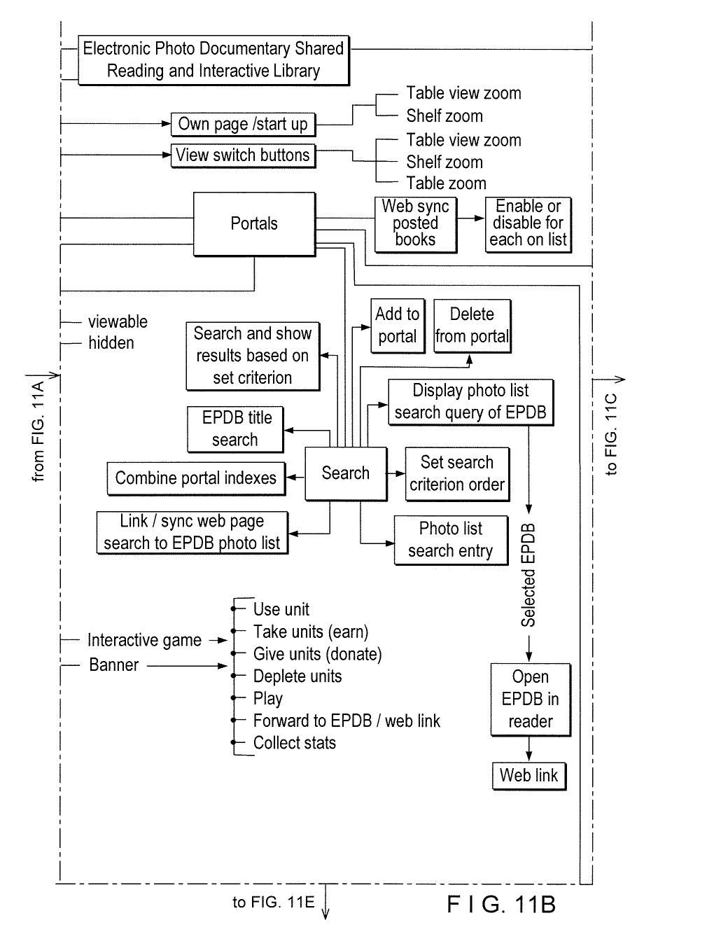

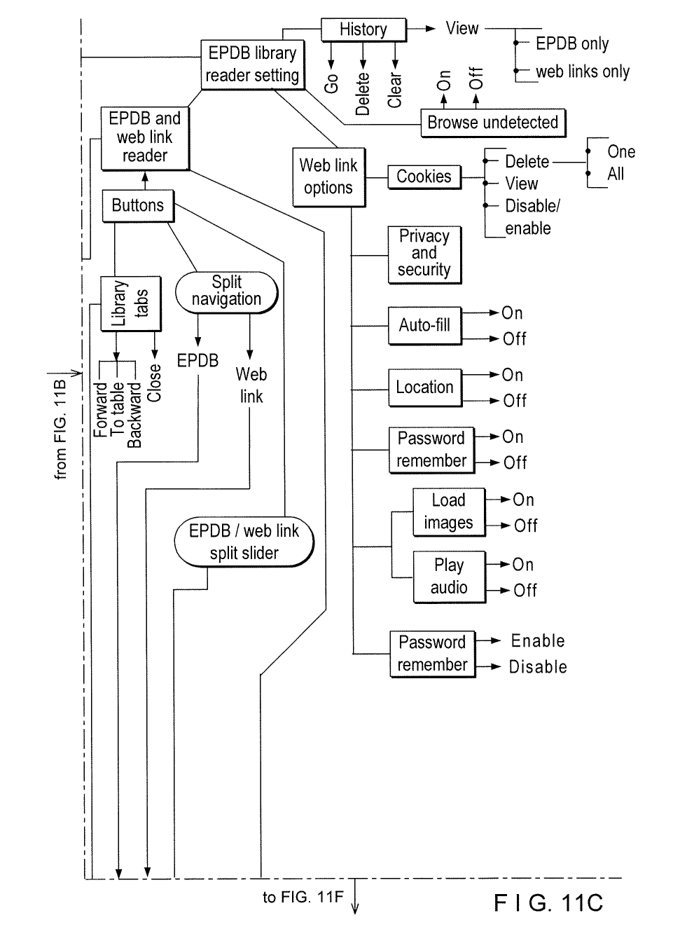

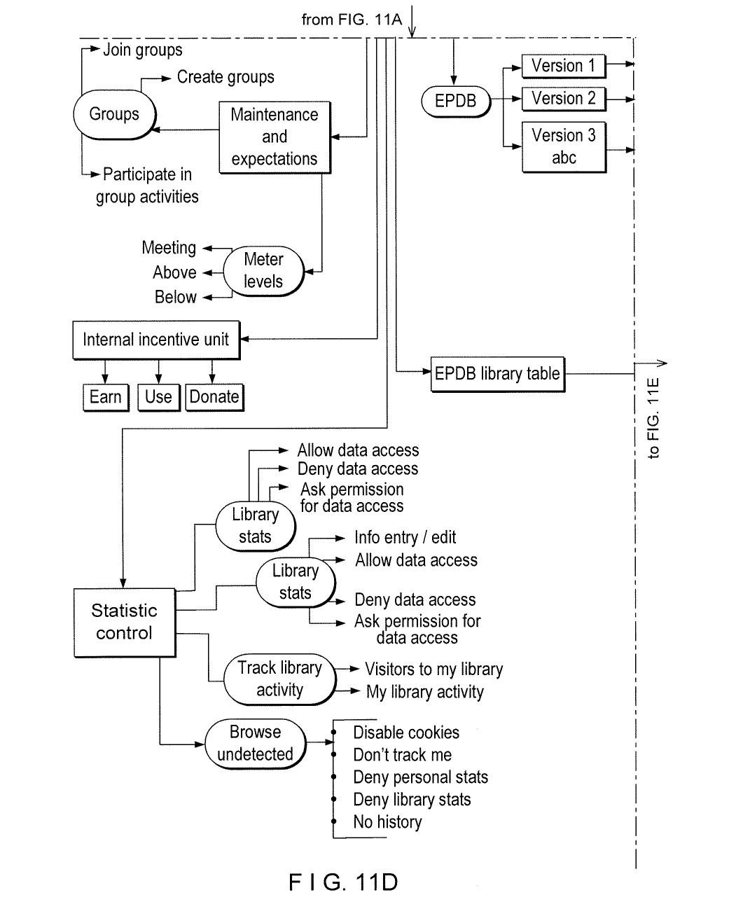

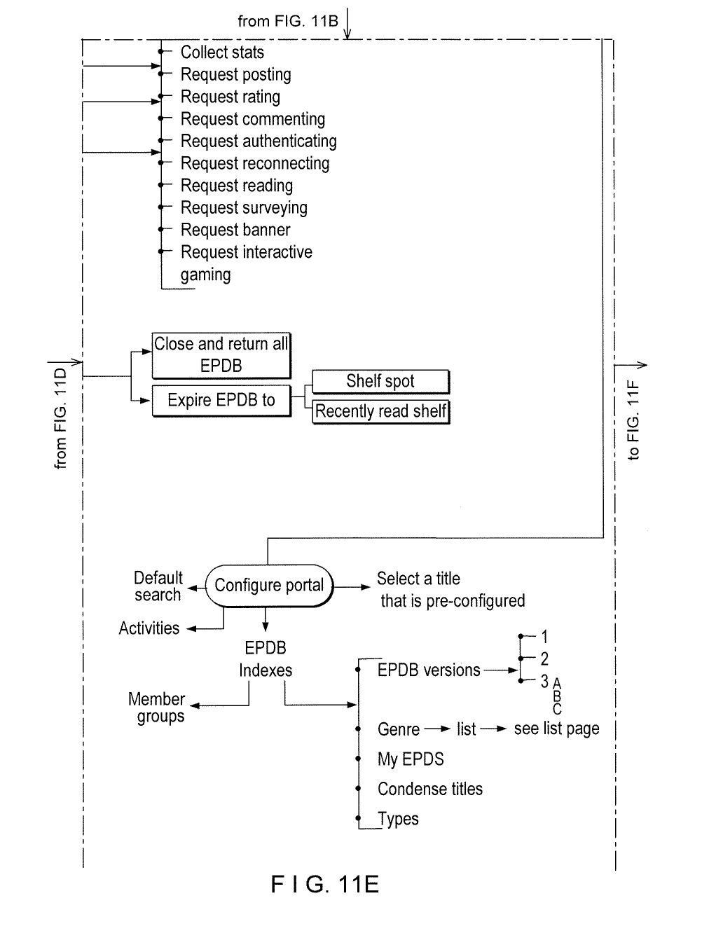

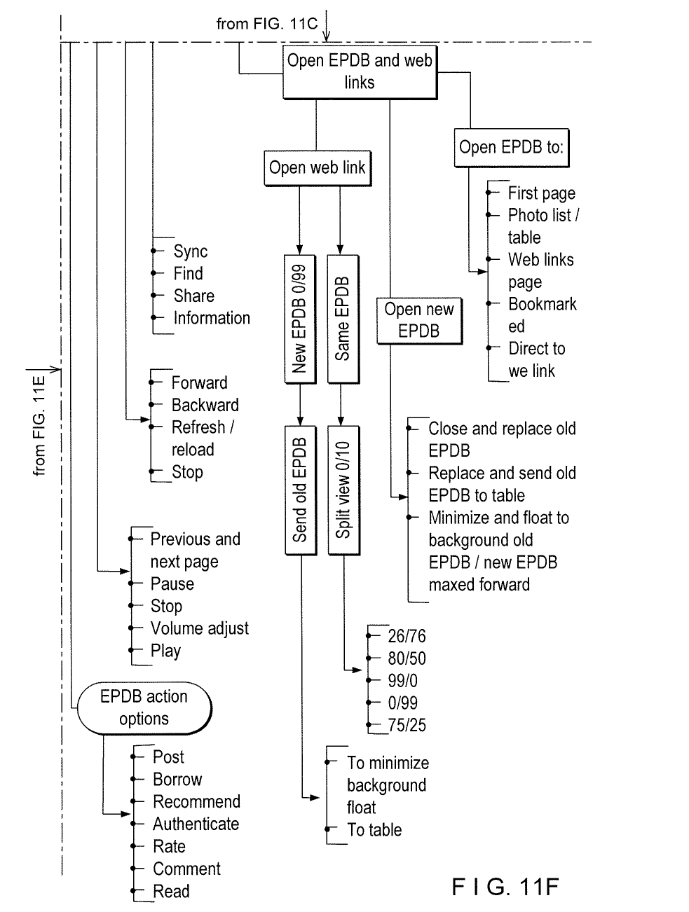

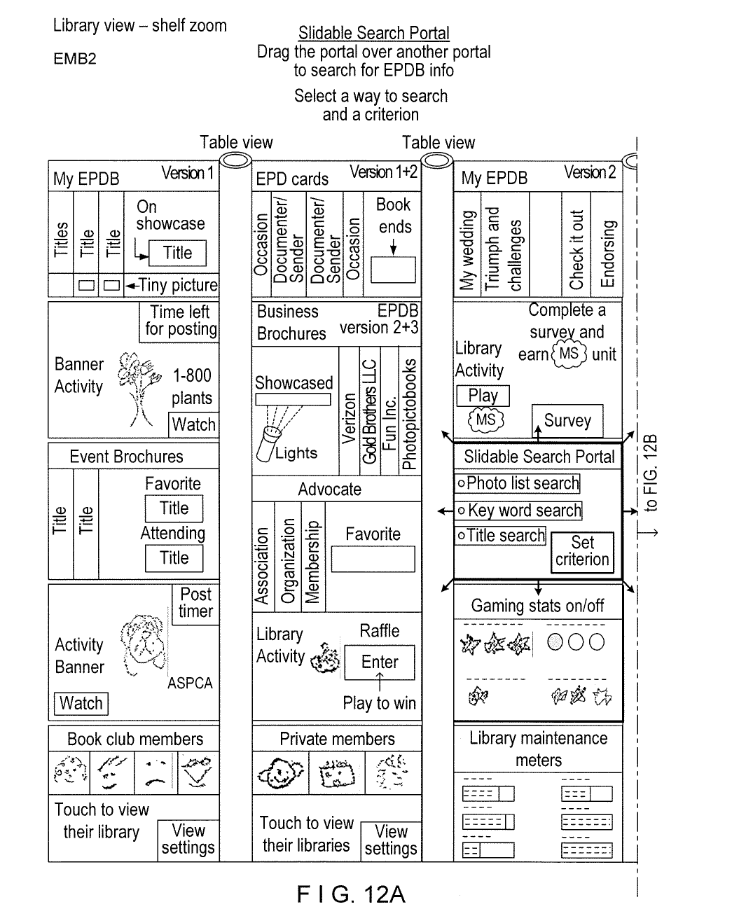

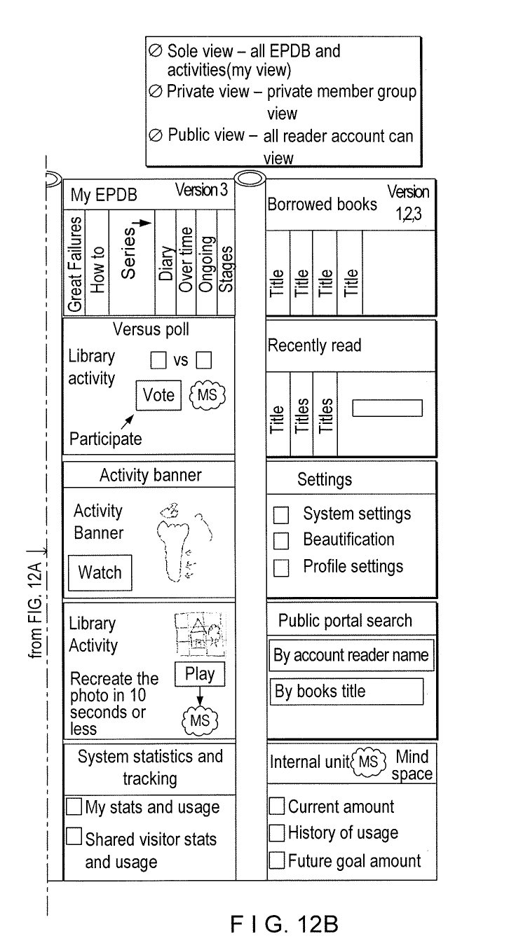

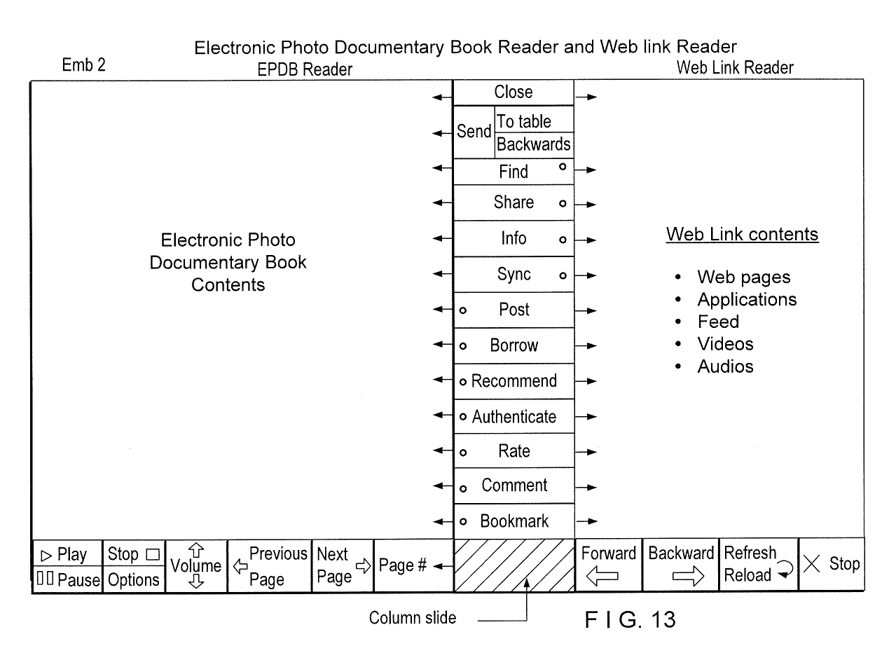

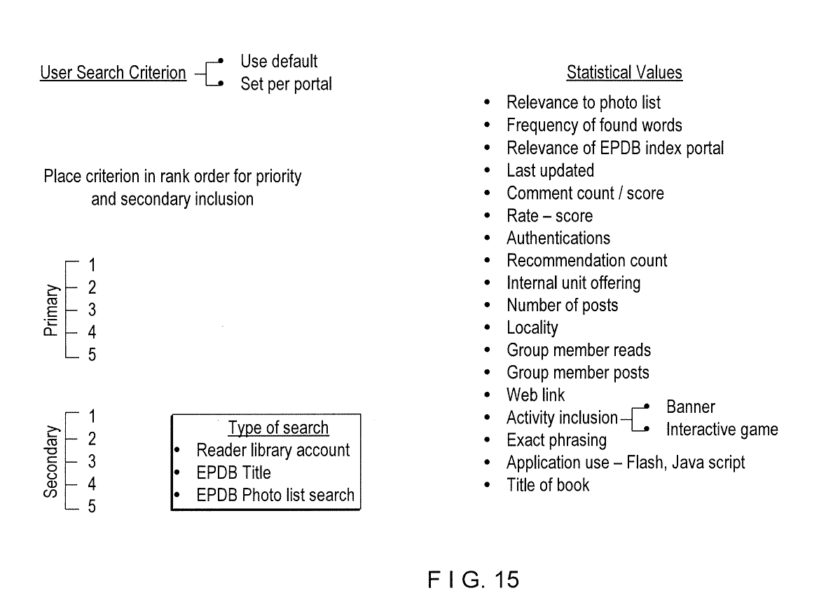

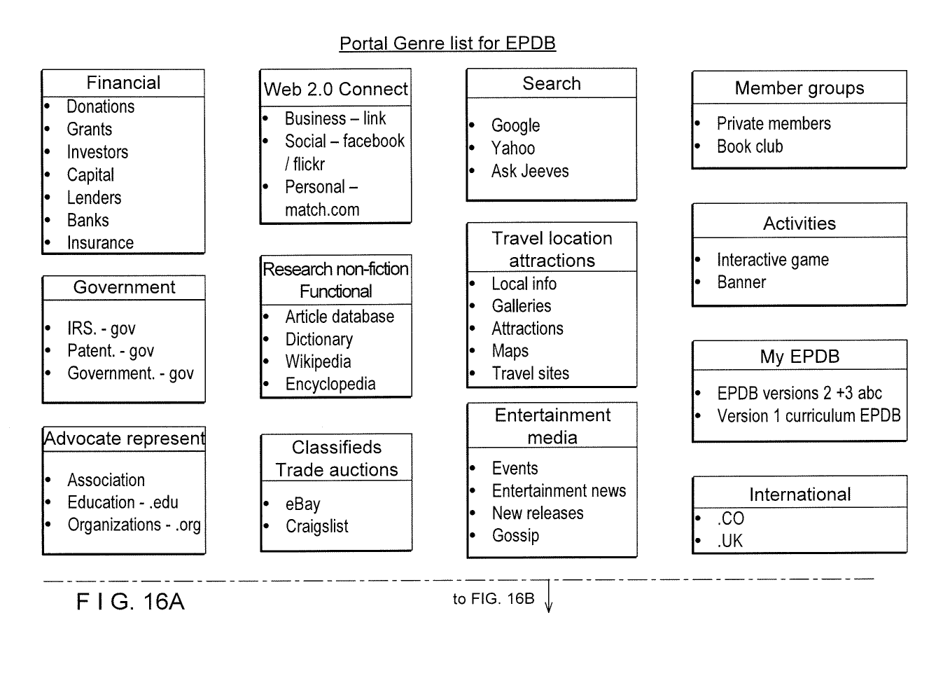

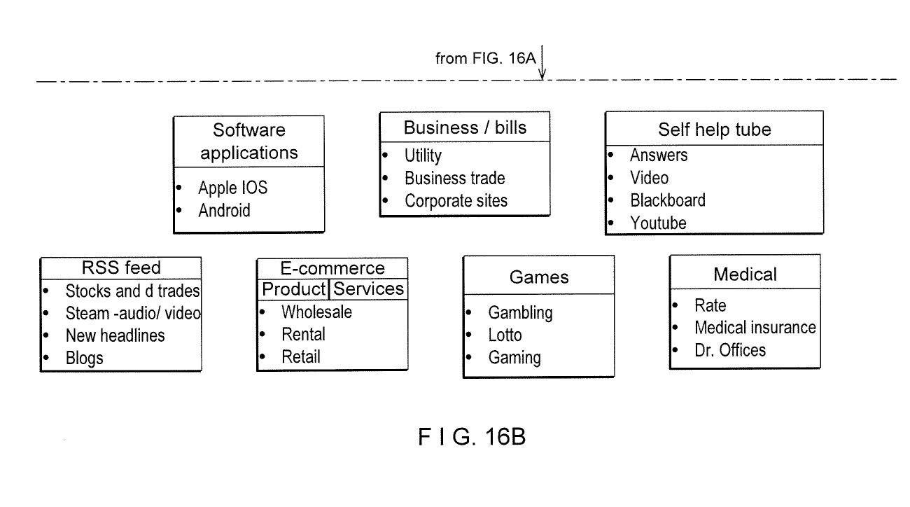

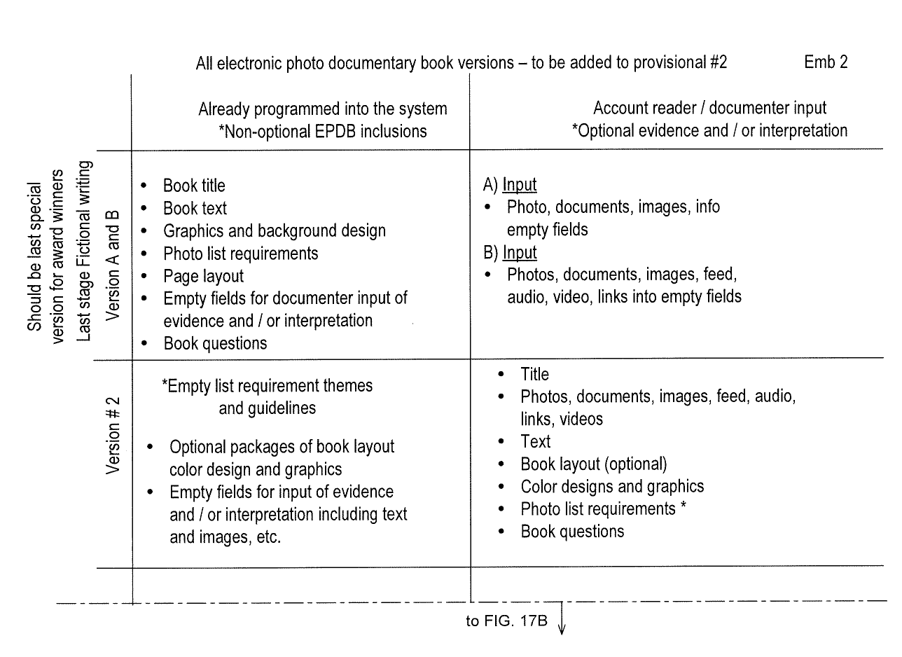

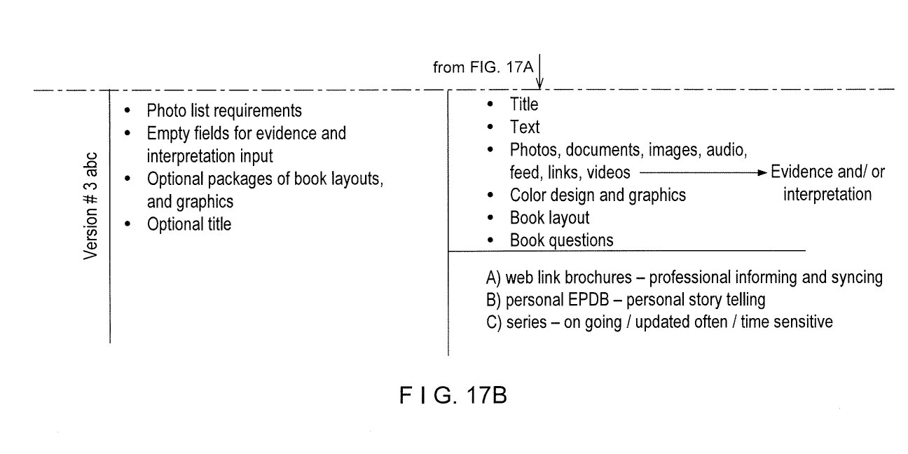

In this aspect the invention provides a method and process for developing reading, speaking, and listening literacy within an incentive library that utilizes the first two aspects described above. A flow diagram of this aspect is shown in FIG. 11 and annotated screen shots in FIG. 12. FIGS. 13 is a screen shot used in this aspect. FIGS. 15 and 16 illustrates the methodology used and depict settings available on the main page used in the third version of my invention.

This aspect of the invention provides a method of developing reading includes collectively introducing and exposing the reader/documenter to opportunities for developing (I) fluency (II) phonemic and phoneme awareness (III) meaning from text (IV) prior knowledge, by the process of creating, completing, and engaging with photo documents.

The process of reading development by completing, reading and engaging with photo documents includes (a) searching for or creating moments and objects for photo capture; (b) capturing all of the required photoslimages/documents/video of the picture list; (c) reading photo documents from a library of photo documents; (d) engaging in related real experience activities as well as media interactive activities; (e) setting reading settings for user enjoyment and reading effectiveness; (f) receiving reading incentives and achievement feedback; (g) applying knowledge and thoughts to related questions The method and process of reading development through photo documenting happens in the manner of a software program that uses an index of the documenters/reader's Electronic Photo Documentary Books and templates in and incentive library. The library serves the function of (1) creating and storing Electronic Photo Documentary Books; (2) providing the reader/documenter opportunities for engaging in book/content related media interactive activities or view demonstrations for book/content related real life activity experiences (3) rewarding the reader/documenter for reading with an internal unit of exchange (MS Mind Space); (4) devising questions from user's photo documents; (5) progressing the reader/documenter along the reading development stages; (6) providing the reader/documenter with achievement feedback; (7) the means for setting the reader enjoyment and effectiveness settings.

After a user/reader/documenter creates a photo document, the user earns some of the internal unit of exchange. The user uses the earned unit to engage in library activities, functions and features. This engagement aids in reading development and allow the reader to progress through the Reading development library stages. Future reading is motivated by the earned activity incentives and progression through the reading development stages.

Creating, reading, and engaging with photo documents within the incentive library develops fluency by frequently exposing the reader to high frequency and sight words found in most trade/textlbasil books of that particular reading level. Frequent exposure through reading and media interactive activities within the incentive library fosters easy recollection of these words, Media interactive activities allow the user to manipulate and play entertaining games and challenges. The program guides and ends with achievement feedback. The word recognition achievements of the user/reader/documenter progresses the reader along the library's reading levels. This controlled system of reading levels aids in fluency by exposing the reader to photo documents they can read independently.

Creating, reading, and engaging with photo documents within the incentive library develops phoneme and phonemic awareness with the use of reading enjoyment and effectiveness settings and the completion and engagement with phonics related photo documents. The reader enjoyment and effectiveness settings develops phoneme awareness by allow the reader set the photo documents to read as entire sentence structures or segment sentences into word chunks based on the users tapping and dragging functions. The settings also allow the user to enable or disable word shading which highlights the letters of the words that correspond to the audible phonetic sound of the words being read. This word shading aids in developing phonemic awareness along with the direct correlation that photo documents create when the user/reader/documenter inserts photos/documents/images/videos from photo documenting activities with the corresponding phonetic content text.

Creating, reading, and engaging with photo documents within the incentive library develops prior knowledge by requiring the reader/documenter/user to engage in specific content related adventures and activities that are age and reading level appropriate. The engagement in activities and the requirement of photo/documentlimage/video capture creates a platform for prior knowledge that will be recalled upon during photo document reading as well as other types of content related text.

Creating, reading, and engaging with photo documents within the incentive library aids the reader/documenter/user in developing meaning from print by leading the reader to reflective and purposeful reading with content specific activities and photo lists. The required picture list and activities personalizes the photo documents which creates a text to self connection between the user/reader/documenter and the text. This text to self connection helps the user/reader/documenter to develop meaning of what is being read.

Meaning is further expanded when the reader/user/documenter reads other user/documenter's photo documents. Reading the same content with relatively different uploaded image/photo/video/documents offers literal and figurative interpretation of the same content which creates self to text to world connections. The reader enjoyment and effectiveness settings allow the user/reader to determines whether the viewable image/documentivideo/photos are personal or of other user/documenters relatively different photo documents.

The photo document incentive library aids the user/reader in developing meaning from text by requiring the reader to connect prior knowledge to the current text knowledge and apply them to a series of content related questions. The assist and assess cards of the Preassembled

Rotating Photo Documentary Books provide an adult facilitator with reflection questions to ignite the child reader/users thoughts for discussion. Both computer and adult facilitator questions aid the reader in formulating meaning of text.

The process of creating, reading, and engaging with photo documents within the incentive library aids in retaining content knowledge through mnemonic techniques of attaching knowledge to relative physical actions and emotional. Memory research has proven that triggering physical and emotional stimuli with relative context aids in future memory and recall of knowledge.

The Electronic Photo Documentary Incentive Library provides direct and explicit instruction within its media interactive activities. The media interactive activities provide the user/reader with achievement specific feedback. This feedback provides opportunity for self reflection and correction. In addition to computer program explicit instruction and feedback, the library provides the adult facilitator with key points for reinforcing instructions and providing instruction.

The drawings includes a flow chart and screen shots of the Electronic Photo Documentary Reading Development and Incentive Library's functions and feature as an explanation of its features and functions.

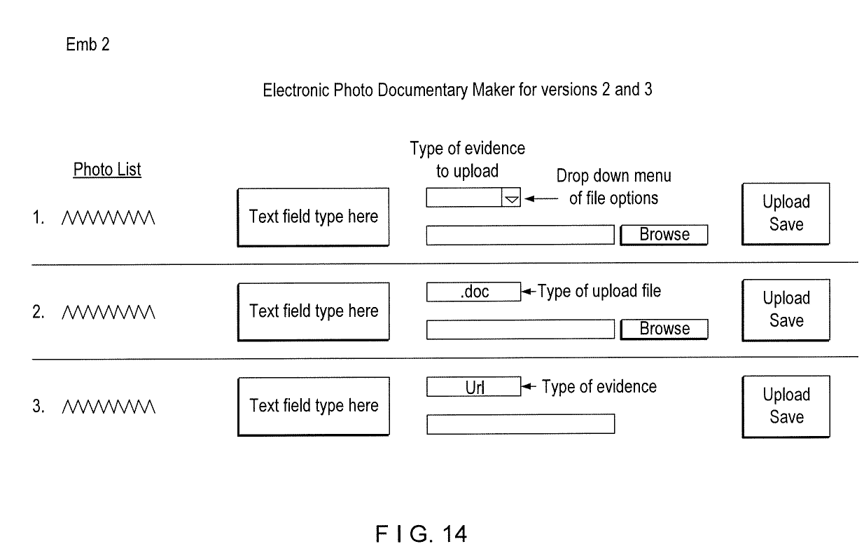

In a fourth aspect of the invention, it provides a method and process for accessing specific information within an index of photo documentaries by the process of sharing, reading, participating in activities, and maintaining photo documentary libraries. This aspect of the invention utilizes the first three aspects described above. This invention's methods and processes utilize its' own in conjunction with the above mentioned inventions' methods and processes. A flow diagram of the steps involved in this aspect is shown in FIG. 11 and an annotated screen shot is shown in FIG. 12. Further information on this aspect is shown in FIGS. 13 to 16.

This aspect of the invention's method of accessing specific information within an Electronic Photo Documentary Library utilizes (1) a progressive incentive library system with account features and functions; (2) Portals that contain EPDB and or Library Activities; (3) Photo lists; (4) an Electronic Photo Documentary Maker; (5) an Electronic Photo Documentary Reader and Web Link.

The progressive library system is a specific library assigned to its specific reader, referred to as account reader. The library system encourages its account reader to progress through scaling library stages to access advanced versions of Electronic Photo Documentary Books, information, activities, and functions. This reader progression is encouraged by awarding function privileges or an internal unit to the account reader for meeting system expectations. Account readers are challenged to maintain library levels, which sets the status and integrity of the library account as well as progress the account reader along the library stages. These challenges are example of system expectations in which the account reader would receive or lose function privelages or internal units. The internal unit can be exchanged for use of library activities, EPDB actions or reaction an library level maintenance. The progressive library of Electronic Photo Documentaries is run by a system where the account reader controls: (a) library views and sharing; (b) automated and default settings; (c) EPDB sharing; (d) account reader grouping; (e) Electronic Photo Documentary Actions; and (f) statistic tracking.

The library views include three options for its account reader to choose from. The shelf zoom view is a wide view of all available portals within the reader's library. The portals contain all of it posted EPDB and activities. The table view enables the reader to view main portals and their contents while viewing a table of open EPDB. The table zoom view is a view without portals. This view includes a close view of all open EPDB that were placed on the table or set in the background float of the library. The account reader sets the view for its shared visitors. Shared visitors are other account readers who visit the account reader's library. The shared visitor views are in shelf view. These views aren't based on a visual appearance of the library as a whole but a view of specific posted EPDB the account reader has permitted certain groups of shared visitors to view. Shared visitors in a personal friends group are able to view specific EPDB from the account reader's library which may differ from the viewable EPDB visible to shared visitors in the co-workers group. Account readers may create and join library member groups in order to link and share libraries as well as provide specific features to specific reader accounts. This grouping can be based on relationships, interests, or unit earnings.

The account reader can set how the library reacts to certain actions by setting library automated reactions. The library can be set to request that a shared visitor rate an EPDB after the third re-read. The library can be set to open EPDB in a specific manner or by default settings. These automated reactions and default settings are further described in the drawings.

The library system creates and classifies its index of EPDB and activities by a system of posting, borrowing, lending, and returning. Account readers post EPDB and activities into the library in which they have created themselves or have asked and received permission to post from another account reader. Posting is a permanent display of an EPDB or activity on an EPDB library shelf. Loaning, lending, and returning are temporary ways to display EPDB and activities. This exchanging of EPDB and activities is referred to as sharing.

Sharing EPDB allows an account reader to perform EPDB actions. Library actions include authenticating, rating, commenting, reading, rereading EPDB. Sharing EPDB activities allows an account reader to participate, play, or watch an EPDB activity. These actions and activities are performed and statistically tracked and monitored according to the account reader's preference. Tracking and monitoring of EPDB activities, aids in organizing and classifying the system's index of Electronic Photo Documentary Books and activities. Organizing and classifying provides the account reader with library statistics such as progression, viewings, participants, EPDB popularity, usage, and opinions.

The library system view and its functionality is designed on a portal system. A group of portals which view as shelves within a library that are used to access information within an index of photo documentary books or activities. Each portal is configured to share display and access specific EPDB information and or activities. Portal configuration can be set to classify and include (a) group members and their share libraries; (b) Library activities; (c) EPDB by genres, versions, types, titles, interests, relationships, or a combination.

Account readers gradually earn the ability to search within a portals universal index, based on a configured search criterion and the EPDB photo lists within the portal. The portal search criterion decides the order in which EPDB are ordered for information access. The search criterion allows the account reader to determine which statistical values are deemed most important when searching for information attached to an Electronic Photo Documentary Book. The portal search allows readers to input search quires as title, specific photo list information, and reader account searches. The portal search uses the qualifying EPDB photo lists and tracking statistics to generate a specified ranking and order of EPDB. This specified search criterion provides the account reader with navigation control and access to the systems overall index of electronic photo documentaries and activities.

The library requires the account reader to have linked an electronic photo documentary reader and maker which is further described in a previous related invention, titled Electronic Photo documentary Book. This reader/maker allows the account reader to create their own Photo Documentary Books and set the reader enjoyment settings for display within their library. The shared library includes a web link reader for the EPDB reader. The web link reader connects to internet links and provides a view for internet data, pages, applications, and/or feeds. The web link features and functions are controlled by the account reader. Web link options include page opening options, privacy and security settings, cookie enabling and disabling, password storing, java enabling, location disclosure, form auto filling and synchronizing for log-in accounts.

The Electronic photo Documentary Shared Reading and Incentive Library is an invention that utilizes library features and functions to encourage and develop reading by accessing specific photo documentary information for reading, sharing and participating in related activities.

1. A kit comprising 1) a pre-assembled literary book containing text and a rotating photo sleeve into which photographs relating to the text may be inserted and predesignated space for recording documenting information and 2) a task card including an “activity” section with suggested activities, a' “photo list” section with a search and find challenge, and a “record recording” section with spaces for written recording of the date of the document.

2. A kit as claimed in claim 1 wherein said rotating photo sleeve serves as a transparent holder of photographs and documents.

3. A method of reading development wherein a student is provided with a book as claimed in claim 1, inserts photographs in the book and executes tasks related to said photograph in accordance with the task card.

4. A method as claimed in claim 3 wherein a record of the task undertaken is made in the book.

5. A kit comprising (1) an electronic templates of a literary book that includes text, graphic designs, illustrations, a picture list as a guide on a search and hunt for photo capture, and empty fields for user input/attachment, (2) a computer program that allows users that provides a means for creating and implementing the electronic book.

6. A kit as claimed in claim 5 wherein a computer program suggests tasks including an “activity” with suggested activities, and a “record recording” section with spaces for recording of the date of the document.

7. A method of implementing an electronic book as claimed in claim 5 which comprises (a) listening to or reading the electronic book as a literary and entertaining agent, (b) sharing the book through a network of other network participants, (c) printing the electronic book onto a plurality of pages.

8. A computer implemented method of reading development by completing, reading and engaging with photo documents includes (a) searching for or creating moments and objects for photo capture; (b) capturing all of the required photos/images/documents/video of the picture list in a kit as claimed in claim 1; (c) reading photo documents from a library of photo documents; (d) engaging in related real experience activities as well as media interactive activities; (e) setting reading settings for user enjoyment and reading effectiveness; (f) receiving reading incentives and achievement feedback; (g) applying knowledge and thoughts to related questions.

9. A computer implemented method of reading development by completing, reading and engaging with photo documents includes (a) searching for or creating moments and objects for photo capture; (b) capturing all of the required photos/images/documents/video of the picture list in a kit as claimed in claim 5; (c) reading photo documents from a library of photo documents; (d) engaging in related real experience activities as well as media interactive activities; (e) setting reading settings for user enjoyment and reading effectiveness; (f) receiving reading incentives and achievement feedback; (g) applying knowledge and thoughts to related questions.
